(19) United States
(12) Patent Application Publication
(10) Pub. No.: US 2004/0179599 A1
(43) Pub. Date: Sep. 16, 2004

(54) Programmable video motion accelerator method and apparatus

(75) Inventors: Chandrasekhar Lakshmanan, Schaumburg, IL (US); Zhong Li Jones, Schaumburg, IL (US); Kathy Moseler, Barrington Hills, IL (US); Raghavan Subramaniyan, Schaumburg, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/387,627

(22) Filed: Mar. 13, 2003

(51) Int. Cl. H04N 7/12

(52) U.S. Cl. 375/240.12; 375/240.24; 375/240.01

(57) ABSTRACT

A programmable video motion accelerator includes a hardware-based video motion estimator (11), a hardware-based difference computer (13), and a hardware-based video motion compensator (12) having at least a first video input and a second video input that is integrally and operably coupled to the video motion estimator. In one embodiment, the video motion estimator and the video motion compensator share programmed elements (15) including, for example, results buffers. A controller (10) can serve to permit selective re-configuration of various elements and data flow paths to thereby facilitate compatible support of various video processing standards and methods.

### RELATED APPLICATIONS

Programmable Video Encoding Accelerator Method and Apparatus (attorney's docket number CML01083N/78585) as filed on even date herewith, and Information Storage and Retrieval Method and Apparatus (attorney's docket number CML00991N/78583) as also filed on even date herewith, wherein both such related applications are incorporated herein by this reference.

### TECHNICAL FIELD

This invention relates generally to video and image processing and more particularly to digital video motion acceleration.

### BACKGROUND

Video processing (including both video motion and still imagery processing) comprises a relatively well known and understood art. To meet various emphasized design requirements, various platforms intended to support such processing have been proposed with substantially total hardware-based implementations (thereby usually tending to emphasize speed and/or bandwidth performance capabilities), substantially total software-based implementations (thereby usually tending to emphasize programmability and flexibility), and mixed hardware/software implementations (usually where the strengths of both are compromised to achieve some limited increase in both speed/bandwidth in conjunction with some flexibility though usually with a number of associated typically undesirable trade-offs and compromises as well).

Generally speaking, such prior art platforms tend to implement only one or a very few video processing algorithms (with this being generally evident even with software-based platforms, often because the algorithms being implemented in this way are themselves carefully constructed and utilized to attempt to minimize the usual reduction in speed/bandwidth that one associates with such an embodiment).

As a simple illustration, some video processing platforms support only one approach to achieve motion estimation and do not integrally support motion compensation. Yet others will support a particular specific algorithmic approach to both motion estimation and compensation. Suggestions to support greater flexibility in this regard tend to rely upon multiplexing architectures that are suitable for some implementations but that tend to be less desirable for integrated solutions where the embodiment preferably comprises a minimal number of integrated circuits.

Such issues become particularly acute when seeking to support video processing capabilities in a small device that relies upon a small portable power supply, and especially so when significant cost restrictions further limit the design freedom of the device architect. For example, a wireless two-way communications device, such as a cellphone, will often be constrained by significant cost and power-efficiency requirements as well as critical form-factor and size limitations. Such issues tend to limit the feasibility of software-based solutions (for example, the power needs required to operate a video processing software platform will often well surpass the performance efficiency targets for such a device) as well as the feasibility of hardware-based solutions (one particular problem is the desire of the manufacturer to offer a basic platform that will function compatibly in a variety of systems, as this need collides with the reality that many different systems in which such a device might be otherwise used tend to require the availability of a number of different incompatible video processing algorithms and techniques). In general, faced with this and other similar quandaries, manufacturers tend to favor hardware-based solutions (to obtain the speed and power consumption benefits) that are unique to corresponding unique market segments and to forgo the economies of scale that one can achieve with a more flexible approach (in order to avoid the speed and power consumption problems associated with such approaches).

### BRIEF DESCRIPTION OF THE DRAWINGS

The above needs are at least partially met through provision of the programmable video motion accelerator method and apparatus described in the following detailed description, particularly when studied in conjunction with the drawings, wherein:

FIG. 1 comprises a generalized block diagram as configured in accordance with an embodiment of the invention; and

FIG. 2 comprises a more detailed block diagram as configured in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, an integrated programmable video motion accelerator can be comprised of a hardware-based video motion estimator, a hardware-based difference computer, and a hardware-based video motion compensator. In a preferred embodiment, the motion compensator will have a first and a second video input wherein the second video input is integrally and operably coupled to the video motion estimator. In a preferred embodiment, these various elements of the accelerator all share a common integrated platform, such as a shared integrated circuit.

In a preferred approach, the motion estimator will support motion estimation with programmed elements. In another preferred approach, both the motion estimator and the motion compensator will share at least a results buffer and may further share certain programmed elements as well (to support, for example, interpolation of luminance and chrominance data).

By then further including an integral datapath/memory controller that is operably coupled with respect to both control and data links to the other components of the accelerator, a wide variety of video processing algorithms can be readily supported by a substantially hardware-based platform, thereby achieving the speed and power performance benefits of a hardware solution while also achieving the broad flexibility and compatibility one associates more commonly with software-based solution. At the same time, the compromised performance one ordinarily associates with such flexibility has been at least substantially avoided.

For example, with these various embodiments, one can provide a device that will support a variety of video processing techniques and algorithms, including even approaches that differ with respect to the need for (and/or kind of) motion estimation and/or motion compensation. Further, if desired, these embodiments will support compatible supportive interaction with other non-integral video processing elements, including a video processing host and/or one or more other video accelerators.

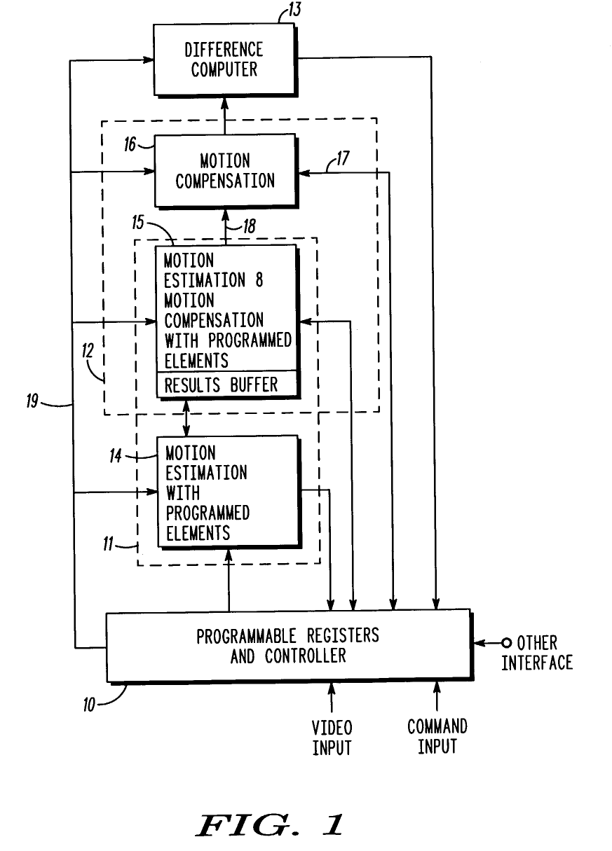

Referring now to the drawings, and in particular to FIG. 1, a video motion accelerator has programmable registers and a controller 10 that comprise a fully feature-programmable datapath/memory controller foundation that serves, as shown below, to interface with other outboard units and to also permit programmed selective element configuration and intercoupling of other components of the accelerator. In this regard, the controller 10 comprises a datapath controller that is integral to such other components. Towards such ends, the controller 10 has at least one video data input (to permit introduction of video information to be processed by the accelerator) and further has one or more command inputs to facilitate interfacing and interacting with at least one other external processor (not shown) such as, for example, a host controller. Other interfaces can also be provided as desired, including, for example, an interface to permit coupling of this accelerator to one or more other accelerators (to permit, for example, serial processing of a different type and/or parallel processing).

In a preferred embodiment, this controller 10 includes all the programmable registers that are visible to a host to facilitate command writes. So configured, upon receipt of commands from such a host, the controller 10 will configure the other components and/or modules of the accelerator to perform and/or otherwise facilitate the required operations. In a preferred embodiment, the controller 10 also includes a picture extension padder as well understood in the art (wherein the picture extension padder serves to replicate the nearest edge pixels when a given motion vector points outside the present frame), though, if desired, a picture extension padder can be provided external to the accelerator (such as native to a given host that interfaces to the accelerator).

Generally speaking, the accelerator also integrally includes a motion estimator 11, a motion compensator 12, and a difference computer 13. In a preferred embodiment, all three such modules are at least substantially hardware-based. So configured, of course, these modules are fast and relatively power-consumption efficient. At the same time, as will be seen below, two of these modules are largely comprised of programmable elements (in response to configuration control signaling from the controller 10) and all of them can be selectively intercoupled as well (again in response to the controller 10).

The motion estimator 11 is comprised of a first part that comprises motion estimation with programmed elements 14. This portion of the motion estimator 11 comprises hardware-based motion estimation elements that are at least to some extent reconfigurable under the control of the controller 10. Another portion of the motion estimator 11 is shared with the motion compensator 12 and comprises hardware-based motion estimation and motion compensation elements 15 that are, again, programmable in response to the controller 10. In a preferred embodiment, these shared elements include at least one or more results buffer. For example, a chrominance results buffer and a luminance results buffer can both be provided in this way. So configured, required circuitry can be reduced while further reducing power consumption needs as these elements 15 are shared by both the motion estimator 11 and the motion compensator 12 (regardless of whether, in a given programmed configuration, both the estimator 11 and the compensator 12 are being used and applied).

The motion compensator 12 is similarly comprised of both the shared programmable elements 15 noted above and additional motion compensation elements 16. The latter elements 16, in a preferred embodiment, need not be programmable as such, but the controller 10 still retains a degree of selective configurability with respect thereto. In a preferred embodiment, this motion compensation module 16 has a first video input 17 (to permit receipt of video data directly from, for example, the controller 10) as well as at least a second video input 18 that is integral to and operably selectively coupled to the video motion estimator 11. So configured, the motion compensator 12 can process video data for motion compensation as sourced by either the motion compensator 12 or the controller 10, thereby permitting considerable programmable flexibility with respect to inclusion or exclusion of the motion estimator 11.

To permit and facilitate such programmable element selection and module configuration, the controller 10 couples via appropriate control lines 19 to each such module. In a similar fashion, raw or processed data is passed from or to the controller 10 and these various modules via corresponding data lines.

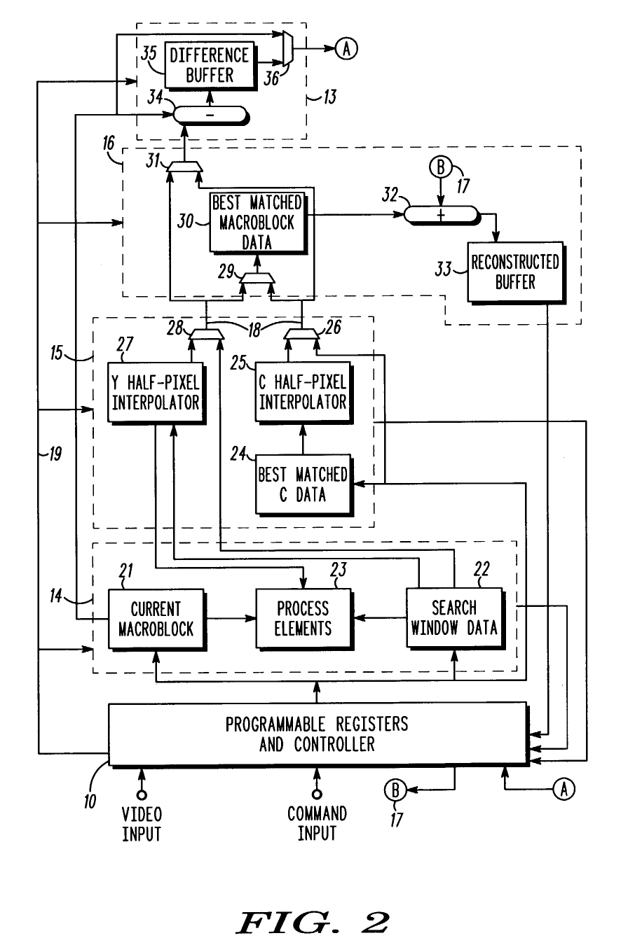

Referring now to FIG. 2, a more detailed embodiment will be presented. Here, it can be seen that, in a preferred embodiment, the programmable elements 14 of the motion estimator include a current macroblock unit 21 (such as a 2 bank buffer having a 6×8×8×8 bit size and serving to store current macroblock data for both the luminance and chrominance information), a search window data unit 22 (such as a 48×48×8 bit buffer) (both as selectively fed by the controller 10) and one or more desired and appropriate motion estimation process elements 23 such as but not limited to absolute difference elements, accumulators, mode calculators, and so forth (with inputs as selectively coupled from the current macroblock unit 21, the search window data 22, and the luminance interpolator portion of the shared programmable elements 15 as related in more detail below. Such constituent elements of a motion estimator are generally well understood in the art and hence additional description will not be provided here for the sake of brevity and the preservation of focus. In general, these parts of the motion estimator 11 are an integral part of the motion estimator and are not used as part of another function or feature. The configuration described, however, will permit considerable flexibility with respect to selection and programmed configuration of such elements via the control line(s) 19 and the controller 10.

The shared programmable elements 15 as generally noted above include, in a preferred embodiment, elements that pertain to both chrominance and luminance information. For chrominance information, a best matched chrominance data buffer 24 (having, for example, a 2×9×9×8 bit size) can selectively receive corresponding video data from the controller 10 and then provide that information to a chrominance half-pixel interpolator 25 as is otherwise well understood in the art. A chrominance data multiplexer 26 then receives the interpolator 25 output and/or the chrominance information as is otherwise provided by the controller 10 as will vary with the programmed behavior of these elements such that the controller selected input is then available to the motion compensator 16 as described below. For luminance information, a luminance half-pixel interpolator 27 as is otherwise well understood in the art receives input from the search window data buffer 22 of the motion estimator and provides a corresponding output to both the process elements 23 of the motion estimator and a luminance data multiplexer 28. The latter also receives luminance data input from the search window data buffer 22 and provides the selected input (as directed by the controller 10) to the motion compensator 16, again as described below in more detail.

So configured, these elements 15 serve the purposes of both the motion estimator 11 and the motion compensator 12. The resultant reduced parts count aids in reducing the required size and power requirements of the resultant device and the selectable configuration permits these elements to support a wide variety of algorithms and other video processing techniques.

The motion compensation elements 16 include, in this embodiment, an input multiplexer 29 (which receives an input from both the luminance and the chrominance output multiplexers 28 and 26 noted above) that feeds a best matched macroblock data buffer (having, for example, a 6×8×8×8 bit size). Another multiplexer 31 also receives the outputs of the luminance and chrominance output multiplexers 28 and 26 and serves to selectively provide such data to the difference computer 13 when so configured by the controller 10. The output of the best matched macroblock data buffer 30 of the motion compensator couples to an adder 32 that has another input operably coupled 17 to a corresponding data output of the controller 10 (this latter input 17 can be used, for example, to input the results of an inverse discrete cosine transform result generator that is external to the programmable video motion accelerator, via the controller 10 to the motion compensator adder 32). The motion compensated results as output by the adder 32 are provided to a reconstructed buffer 33 (having, for example, a 6×8×8×8 bit size) which then couples to a data input of the controller 10.

So configured, the motion compensator can be configured as desired to facilitate motion compensation with various data sources and as a function of compensation information that is itself based upon selectably variable data sources. Again, control signaling from the controller 10 via the control line(s) 19 can be used, at a minimum, to control the various described multiplexers to select and steer the various described data inputs and outputs as appropriate to effect a given video processing approach.

The difference computer 13 comprises, in this embodiment, a subtractor 34 operably coupled to the output of the motion compensation multiplexer 31 to receive a first set of luminance and chrominance data and to an output of the current macroblock 21 of the motion estimator 14 to receive a second set of luminance and chrominance data. A difference buffer 35 stores the resultant difference information. An output multiplexer 36 then serves to selectively output to the controller 10 either the contents of the difference buffer 35 or the luminance and chrominance information as sourced by the current macroblock 21 of the motion estimator.

The above embodiment can be readily realized as a single integrated circuit. As already noted, the motion estimation, motion compensation, and difference calculator are all substantially hardware-based and yet are readily reconfigurable in a selectable and programmable fashion via the controller 10 (for example, the various multiplexers can be used, singly or in multiples, to select or de-select various portions of these modules for usage in a given application).

The resultant platform comprises a highly flexible enabling mechanism while also remaining substantially hardware-based and relatively quick and energy efficient. As one illustration, this platform can readily serve to support international video compression standards such as H.263 and MPEG-4. Motion estimation tends to be a data intensive operation and often requires a large proportion of processing power. In many prior art embodiments, motion estimation can contribute upwards of 70% of the total computational loading in a given encoder. This performance can be considerably bettered here, in part by selecting to integrate motion estimation with motion compensation to reduce host-accelerator communications and thereby reducing bandwidth requirements. The available reduction in memory accesses combined with the power saving techniques reduces the overall power required needed for an encoding system. Further, the programmable flexibility afforded by these embodiments readily permits a user to update algorithms for, for example, visual quality enhancements.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, the described macroblock data (luminance and chrominance) and the corresponding search window region could be arranged in multiple banks to exploit the regular flow of data required for motion estimation. For example, the macroblock and search window buffers 21 and 22 could be comprised of four memory banks. The process elements 23 could include four corresponding summation of absolute difference (SAD) units that could be used in a motion estimator calculator to perform four summation of absolute difference computations. Such an arrangement of data in the buffers could increase the data handling efficiency and ease complexity during address generation. The macroblock data could be loaded first and computations to calculate parameters such as mean and the SAD mean (Σ(xᵢ−mean) i=0 . . . 255) for use in determining intra-thresholds could be performed in parallel with fetching and, if required, the picture extension of the search window data.

It should also be clear that, notwithstanding the inclusion and availability of the above described modules, if desired and as appropriate to a given application one may nevertheless effect one of more of the supported functions or features external to the accelerator. As one pertinent example, an external processor (including but not limited to any of a microprocessor, a digital signal processor, or another accelerator platform) can be used to execute, in tandem with the functioning of the accelerator described above, a motion estimation algorithm notwithstanding the availability of the described native motion estimator 11.

We claim:

1. A programmable video motion accelerator comprising:
a hardware-based video motion estimator;
a hardware-based difference computer
a hardware-based video motion compensator having:
a first video input;
a second video input that is integrally and operably coupled to the video motion estimator.

2. The programmable video motion accelerator of claim 1 wherein the video motion estimator includes a picture extension padder.

3. The programmable video motion accelerator of claim 1 wherein the video motion estimator includes a results buffer.

4. The programmable video motion accelerator of claim 3 wherein the results buffer includes both a chrominance results buffer and a luminance results buffer.

5. The programmable video motion accelerator of claim 3 wherein the results buffer is integrally and operably coupled to the second video input.

6. The programmable video motion accelerator of claim 1 wherein the video motion compensator includes a motion compensation results output.

7. The programmable video motion accelerator of claim 6 and further comprising an integral datapath controller that is operably coupled to the video motion compensator.

8. The programmable video motion accelerator of claim 7 wherein the datapath controller operably couples to the motion compensation results output of the video motion compensator.

9. The programmable video motion accelerator of claim 8 wherein the video motion compensator further includes an integral adder and wherein the datapath controller further operably couples to the adder, such that the datapath controller can selectively operatively couple the motion compensation results output of the video motion compensator to the adder of the video motion compensator.

10. The programmable video motion accelerator of claim 1 wherein the video motion estimator includes at least one interpolation circuit.

11. The programmable video motion accelerator of claim 10 wherein the video motion compensator selectively shares usage of the at least one interpolation circuit.

12. The programmable video motion accelerator of claim 11 and further comprising an integral datapath/memory controller that is operably coupled to the video motion estimator and the video motion compensator such that the datapath/memory controller selectively controls shared usage of the at least interpolation circuit by the video motion compensator.

13. The programmable video motion accelerator of claim 1 and further comprising a datapath/memory controller and host interface that is operably coupled to the video motion estimator and the video motion compensator.

14. The programmable video motion accelerator of claim 13 wherein the datapath/memory controller and host interface further comprises an accelerator interface such that the programmable video motion accelerator is selectively coupleable to at least one other external processor.

15. A method comprising:
providing a programmable integral hardware platform having:
a video motion estimation circuit;
a difference computer circuit; and
a video motion compensation circuit;
using the programmable integral hardware platform to selectively accelerate at least one of video motion estimation, difference computation, and video motion compensation.

16. The method of claim 15 wherein providing a programmable integral hardware platform further includes providing a video motion estimation circuit having at least one interpolator circuit that is selectively directly coupleable to an input of the video motion compensation circuit.

17. The method of claim 16 wherein providing a video motion estimation circuit having at least one interpolator circuit includes providing a video motion estimation circuit having at least two interpolator circuits that are selectively directly coupleable to at least one input of the video motion compensation circuit.

18. The method of claim 17 wherein providing a video motion estimation circuit having at least two interpolator circuits includes providing a video motion estimation circuit having at least a luminance data interpolator circuit and a chrominance data interpolator circuit.

19. The method of claim 18 wherein providing a video motion estimation circuit having at least a luminance data interpolator circuit and a chrominance data interpolator circuit includes providing a video motion estimation circuit having at least a luminance data half-pixel interpolator circuit and a chrominance data half-pixel interpolator circuit

20. The method of claim 15 wherein providing a programmable integral hardware platform further includes providing a video motion estimation circuit having a picture extension padding circuit.

21. The method of claim 15 wherein providing a programmable integral hardware platform having a video motion estimation circuit includes providing a video motion estimation circuit having native hardware-based local buffers for search window data, macroblock data, and best-matched chrominance data.

22. The method of claim 21 wherein providing a programmable integral hardware platform having a video motion estimation circuit includes providing a video motion estimation circuit having local buffer data access.

23. The method of claim 15 wherein using the programmable integral hardware platform to selectively accelerate at least one of video motion estimation and video motion compensation includes selecting a particular motion estimation algorithm from amongst a plurality of motion estimation algorithms and programming the programmable integral hardware platform to compatibly facilitate the particular motion estimation algorithm.

24. The method of claim 15 and further comprising using at least one external processor to process a motion estimation algorithm.
